(19) United States
(12) Patent Application Publication
(10) Pub. No.: US 2024/0320621 A1
(43) Pub. Date: Sep. 26, 2024

(54) INVENTORY TARGET-BASED PRODUCT RESTOCK METHOD AND SYSTEM

(71) Applicant: SHENZHEN MEIYUNJI NETWORK TECHNOLOGY CO, LTD., Shenzhen (CN)

(72) Inventors: Zhichao WANG, Shenzhen (CN); Donghui LU, Shenzhen (CN); Wei HU, Shenzhen (CN); Shoubao CHEN, Shenzhen (CN)

(73) Assignee: SHENZHEN MEIYUNJI NETWORK TECHNOLOGY CO, LTD., Shenzhen (CN)

(21) Appl. No.: 18/610,469

(22) Filed: Mar. 20, 2024

(30) Foreign Application Priority Data
Mar. 21, 2023 (CN) 2023102727486

(51) Int. Cl. G06Q 10/087

(52) U.S. Cl. CPC G06Q 10/087

(57) ABSTRACT

An inventory target-based product restock method, including obtaining the FBA inventory data of the product, setting the shipping logistics and duration from the pre-storage warehouse to the FBA warehouse, setting the daily average sales, interval days, and safety days of the product, so that the sum of the interval days and safety days multiplied by the daily average sales equals the target stock; calculating the restock time for the product to arrive at the FBA warehouse on the day when the FBA inventory is reduced to the safety stock as the temporary restock day; calculating the quantity of products needed to reach the target stock on the day when the temporarily restocked products arrive at the FBA warehouse as the temporary restock quantity; and using the temporary restock day and quantity as the recommended restock day and quantity for this restock, and generate restock suggestions.

### TECHNICAL FIELD

This embodiments relate to the field of computer technology, and pertain to an inventory target-based product restock method, a multiple products based product restock method, a specified delivery time based product restock method, and corresponding systems for each method.

### BACKGROUND

With the rise of global e-commerce, international retail trade has experienced rapid development. Many domestic small and medium-sized e-commerce sellers have expanded their retail business to foreign markets. Along with the development of cross-border business, e-commerce ERP systems based on ERP software have gradually emerged. E-commerce ERP system can be deeply connected with the e-commerce platform to help domestic small and medium-sized e-commerce sellers to unify the management of their overseas stores, to solve the obstacles brought by language differences, and to realize the management of hundreds of e-commerce stores by a single operator at the same time, which greatly improves the efficiency of store operations.

E-commerce ERP system accesses and controls the stores on e-commerce platforms through established rules, handling dynamic data in various aspects of store operations. The data management is complex, and it also needs to meet the operation convenience requirements of various types of users (sellers). Therefore, the existing commercialized e-commerce ERP systems are still in the stage of gradually updating and improving their functional modules. The algorithms and rules set by software companies in developing their own e-commerce ERP systems are also fundamentally different. The functional modules will continue to develop new versions as user demands change, in order to be compatible with more usage scenarios.

Taking the example of an ERP system for managing Amazon's e-commerce platform store, the FBA restock programme (recommendation) module calculates the appropriate restock time and quantity based on sales data, warehouse data, and logistics limitation period, and provides them to the operations personnel in the form of restock programme. Restock programme closely related to product, sales, procurement, logistics, and warehouse data are an important part of e-commerce inventory management. Failure to restock in a timely manner can result in out-of-stock situations, while excessive restock requires more investment in stocking expenses (such as procurement and warehouse costs), which reduces the efficiency of capital turnover.

The current restock programme of the ERP system is primarily based on a fixed restock cycle. When the inventory of FBA warehouses is below the safety stock level, restock is initiated. The restock quantity is calculated as (logistics limitation period+safety days+restock cycle)*daily sales−FBA inventory. This periodic restock programme is timely and convenient for using fixed shipping date in cross-border logistics as the delivery time for restock, achieving regular restock. Whereas, this periodic restock programme cannot flexibly adjust the restock quantities corresponding to restock and different dates. It is usually only suitable for products with stable sales (boutique-type products), and is not suitable for newly launched products with unstable sales or products with overall high sales but low sales per item (distribution-type products). Additionally, the current restock programme of the ERP system is usually reminded on the day of restock, requiring immediate restock on the suggested restock date, which is inconvenient for operational personnel to control the pace of restocking. Moreover, the restock quantity suggested by the current restock programme includes the sales volume during the logistics limitation period, resulting in excess inventory.

Furthermore, the current restock programme seldom take into account the impact of factors such as the minimum shipment quantity of logistics, the minimum procurement volume of products, purchase lead time, and delivery time on the process calculating the restock date and quantity. This leads to significant discrepancies between the restock programme and real shipping scenarios, making it unable to directly generate shipping and procurement plans and require manual verification.

The existing restock programme mostly calculate the delivery time and restock quantity for individual product, and is unable to restock multiple products at the same time and give corresponding programme. In addition, the existing restock programme are typically based on the time it takes for FBA inventory to decrease to a safe level or based on a fixed restock cycle. It cannot deliver goods in advance or delay delivery, nor give suggestions corresponding to restock quantity based on the delivery time t specified by the user.

Other technical issues related to this application will be further elaborated in the following text. The aforementioned content is only intended to facilitate the understanding of the technical programme proposed in this application and does not imply that all of the aforementioned content is existing technology.

### SUMMARY

The main purpose of this application is to provide an inventory target-based product restock method and an e-commerce ERP system, in order to reduce inventory costs and increase flexibility in restocking store products, make the restock recommendation applicable to the replenishment of distribution-type products. Additionally, this application also provides a multiple products based product restock method and system, used for multiple commodities to be consolidated or restocked at the same time. Furthermore, provides a specified delivery time based product restock method and system, providing corresponding restock suggestions when the user specifies the delivery time.

To achieve the above objectives, this application proposes an inventory target-based product restock method, for the restock programme (recommendation) module of an e-commerce ERP or platform system. The method comprising the following steps:

Step S1: Obtain data access permission for the store's products and retrieve the FBA inventory data, the FBA inventory data comprising FBA inventory Q1, FBA on-hand quantity Q11, and FBA in-transit quantity Q12 at the current time t0. Set up the shipping logistics and corresponding logistics lead time (T2) for sending the products from the warehouse to the FBA warehouse.

Step S2: set the daily average sales X and safety days T32 of the products, multiply the safety days T32 by the daily average sales X to obtain the safety inventory Q5 of the products; set the interval days T31 or target inventory Q6 of the products such that the sum of the interval days T31 and safety days T32 multiplied by the daily average sales X equals the target inventory Q6, the interval days T31 is used to adjust the frequency of product restock, and the target inventory Q6 is a constant greater than the safety inventory Q5.

Step S3: calculate the temporary restock day tx for the product to be restocked from the pre-storage warehouse to the FBA warehouse based on the product's FBA inventory Q1, safety inventory Q5, daily average sales X, and logistics lead time T2, the temporary restock day tx refers to the restock time when the product arrives at the FBA warehouse on the day when the FBA inventory Q1 decreases to the safety inventory Q5 by the daily average sales X of the product.

Step S4: calculate the temporary restock quantity Nx based on the target inventory Q6, temporary restock day tx, daily average sales X, and logistics lead time T2 of the product, the temporary restock quantity Nx is the quantity of product restocked on the temporary restock day tx, so that on the day when the product restocked on the temporary restock day tx arrive at FBA warehouse, the FBA on-hand quantity Q11 equals the target inventory Q6.

Step S5: generate the restock recommendation A based on the temporary restock day tx and temporary restock quantity Nx, the restock recommendation A includes the delivery recommendation generated based on the temporary restock day tx and temporary restock quantity Nx;
or, determine the suggested restock day tj based on the temporary restock quantity Nx, then determine the suggested restock quantity Nj based on the suggested restock day tj, then generate the restock recommendation B based on the suggested restock day tj and suggested restock quantity Nj.

Other features and technical effects of this application will be described and explained in the later part of the specification. The technical problem-solving approach and related product design plan of this application are as follows:

To reduce the stocking cost of goods, the current common solution is to increase the accuracy of daily average sales estimation or reduce the safety days to minimize the quantity of additional stocked goods. However, this solution is difficult to accurately control the stocking quantity of distribution goods with unstable sales. The applicant has found that by increasing the frequency of goods delivery, it is possible to control the timing of arrival of restocked goods to FBA warehouses in batches, ensuring that most of the delivered goods are in transit status and only a small quantity of goods in storage at FBA warehouses. In other words, FBA In-transit Quantity is greater than FBA on-hand quantity. By controlling and increasing the frequency of goods delivery, the quantity of goods stored in warehouses can be reduced.

Based on the strategy of increasing delivery frequency, the applicant proposes the concepts of interval days and target inventory. Interval days are defined as the estimated time between two consecutive deliveries using a specific logistics service. It serves as the initial benchmark for product delivery. The interval days are used to adjust the frequency of restock. For the same logistics service, the interval days are usually set as a constant. A smaller interval days value indicates a higher delivery frequency needed for the product, while a larger value indicates a lower frequency. The interval days represent the ideal time interval between two consecutive deliveries. However, the actual delivery time can vary. It is calculated based on the target inventory, which is determined by considering the estimated sales within the safety days. Each restock is then made to maintain the target inventory. The interval days are adjusted accordingly to achieve the desired delivery frequency. The interval days is the interval between two shipments of goods before and after the ideal state. In the actual scenario, the delivery time of each shipment of goods can be changed and calculated based on the target inventory.

Specifically, set a smaller interval days value (typically smaller than the logistics lead time) to ensure that each restock results in a relatively smaller quantity of goods being delivered. This increases the frequency of restocks and controls the FBA on-hand quantity to be equal to the fixed target inventory. Alternatively, the restock day and the interval between two consecutive deliveries can be determined based on the time it takes for FBA inventory to reach the safety stock level. The target inventory for a product remains a constant value and serves as another benchmark indicator, in addition to the safety stock level. As shown in FIG. 4, the target inventory is greater than the safety stock level and is calculated as the sum of the safety days and the interval days, multiplied by the daily average sales.

This target inventory-based restock programme uses the target inventory as the benchmark for each restock, in this way, the FBA on-hand quantity can be restored to the quantity of target stock after each replenishment of goods (products), ensuring that the FBA on-hand quantity is always between the safety stock and the target stock. This enhances accurate control of FBA warehouse inventory. Compared to existing restock recommendations, the target inventory-based restock solution allows for flexible selection of the current or future time as the restock time and calculates the corresponding restock quantity. It also enables controlling the time it takes for the goods to arrive at the FBA warehouse based on the logistics lead time of various shipping programmes and setting the appropriate interval days, thereby reducing the delivery time interval between the two restocks, reducing the actual storage quantity of FBA warehouse goods, significantly reducing inventory costs, and reducing the risk and recovery time of stockouts. By flexibly adjusting the restock time of goods, different products can be bundled and shipped on the same day, making this restock programme suitable for restock of distribution-type products (referring to stores with a variety of products and low sales volume per product) and for unstable sales of newly launched products. It is also user-friendly for beginners. On the other hand, since the new restock solution is more timely, the parameters such as interval days and safety days can be set lower when setting the restock recommendations, further reducing the FBA warehouse inventory of goods. It also reduces the impact of estimation deviation in daily sales on the recommended restock quantity. The other implementation plans and technical effects will be explained in the following text.

Furthermore, this application also provides a multiple products based product restock method and system, as well as a restock recommendation module for e-commerce ERP systems or e-commerce platform systems. The programme includes adding the products that need to be restocked to the restock recommendation list, setting the logistics lead time (T2) and minimum shipment quantity (N5) for each product. It also involves selecting the shipment time (td), considering the products to be shipped on the same day as the pending products. The total restock quantity (Nd) of the pending products is then calculated. If Nd≥N5, a restock recommendation is generated. If Nd<N5, the products to be shipped after td are considered as pre-shipping products, and the products to be consolidated are determined based on the consolidation priority level of each pre-shipping product. If the total restock quantity of all pending products and pre-shipping products at td is still less than N5, the shipment time td is postponed until the total shipment quantity of pending products and pre-shipping products≥N5, and then a restock recommendation is generated.

The specific implementation plan will be described later in the text. Compared to existing restock recommendation modules that can only calculate the restock time and quantity for individual products and cannot restock multiple products simultaneously, the restock programme based on multiple products in this application enables simultaneous restock of multiple products. When the shipment quantity of an individual product is less than the minimum shipment quantity (N5), the most suitable product and consolidation time are calculated, and corresponding restock recommendations are provided. This allows each individual product to be restocked with a quantity less than N5 while also allowing users to choose slower but cheaper shipping programmes with higher minimum shipment quantities, thereby significantly reducing inventory costs. The consolidation of multiple products for shipping not only increases the overall restock frequency of multiple products but also reduces the shipment quantity of individual products in each batch, preventing a significant delay in shipment due to failure to meet the minimum shipment quantity for logistics. This restock programme based on multiple products allows for shipments to be made for most products every day without needing to be below the safety stock level.

Furthermore, this application also provides a specified delivery time based product restock method and system, which is used in the restock recommendation module for e-commerce ERP systems or e-commerce platform systems to provide corresponding restock recommendations after the user specifies the shipment time. The technical approach of restocking based on a specified shipment time is based on the target inventory Q6 to determine the shipment quantity Nt of the product at each specified shipment time t. This includes obtaining the FBA inventory data of the product, setting the shipment logistics and logistics duration from the pre-storage warehouse to the FBA warehouse for the product, setting the average daily sales, interval days, and safety days of the product, so that the sum of the interval days and safety days multiplied by the average daily sales equals the target inventory. The specified shipment time t is set and the corresponding restock quantity Nt is calculated. The restock quantity Nt is the quantity of the product that needs to be restocked on the day the product restocked at time t reaches the FBA warehouse, so that FBA on-hand quantity on that day is equal to the target inventory Q6. Then, based on the shipment time t and the corresponding restock quantity Nt, a restock recommendation is generated. The specific implementation plan will be described in detail later in the text.

This restock programme based on a specified shipment time allows for restock or consolidation without the need to be below the safety stock level, allowing most products to be shipped every day. Due to the future specified shipment time, multiple pending products can be consolidated and shipped together, reducing the quantity of each restock and shortening the time between two shipments. This helps to reduce logistics costs and inventory costs.

The restock recommendation module in this application can be used in e-commerce ERP systems or e-commerce platform systems, such as Amazon, Alibaba, eBay, and other e-commerce platform systems, to execute the operations and algorithms included in the restock recommendation module.

Furthermore, this application also provides a server that includes a storage device and a processor. The restock recommendation module and its system in this application are stored in the storage device, and the processor can execute the operations, instructions, and corresponding algorithms of the restock recommendation module and its system.

Furthermore, this application also provides a computer device that includes a storage device and a processor. The restock recommendation module and its system in this application are stored in the storage device, and the processor can execute the operations, instructions, and implementation programmes of the functional modules in e-commerce ERP systems.

Declaration: For the sake of simplicity, this application primarily describes the technical solutions based on the Amazon platform, but it should be noted that the e-commerce platform mentioned in this application can also include other platforms besides Amazon. Referring to FIG. 1, the e-commerce ERP system in this application includes one or more functional modules such as the product module, sales module, procurement module, logistics module, warehouse module, finance module, advertising module, customer service module, tool module, permission management module, and data module. These functional modules can be integrated with each other or exist independently. Additionally, a functional module can also serve as a sub-module of another functional module. The operators of the ERP system in this application can also be referred to as store managers, sellers, operators, operation personnel, or users, and their identity is not strictly limited unless specifically stated.

In this application, terms such as “days,” “lead time,” “duration,” “timeliness,” and other time-related names are industry conventions and all indicate the concept of “length of time.” For example, safety days, interval days, available days, purchase lead time, purchase duration, stock preparation timeliness, etc. The default time unit is days. In practical application scenarios involving other time units, other time units can be converted to days or days can be converted to other time units. In this application, “shipping” and “restock” are industry conventions and have the same meaning.

In this application, the future time “t” can include the current day because when calculating, the current day has not ended yet and the sales data for the current day is not yet available. The sales of the current day can be considered as future sales data. In this application, “goods” and “products” are commonly used terms in this field and have the same meaning; no distinction is made between them.

The meanings and descriptions of nouns in the e-commerce field in this application (letters other than English words and field symbols in this application are not case-sensitive):
(1) FBA (Fulfillment by Amazon) refers to the process where sellers send their products to Amazon's fulfillment center for storage, management, picking, packing, and fast shipping, as well as return and exchange services. In this application, FBA broadly refers to the process where sellers send their products to an e-commerce platform's fulfillment center, and the platform takes care of inventory management, packaging, shipping, and customer service. Correspondingly, in this application, FBA warehouse refers to the e-commerce platform's warehouse (i.e., the platform's fulfillment center warehouse).
(2) Local warehouse refers to the warehouse located at the place of purchase. After purchasing the goods, delivery and quality inspection are completed at the local warehouse. If the seller directly ships the goods from the supplier's warehouse after purchase, then the supplier's warehouse serves as the local warehouse. Overseas warehouse refers to a transit warehouse close to the FBA warehouse. Sellers can store goods in the overseas warehouse in advance, and when the FBA warehouse is out of stock, they can ship from the overseas warehouse to the FBA warehouse to reduce restock time and warehousing costs. Both the local warehouse and overseas warehouse serve as pre-storage warehouses for goods. When a local warehouse contains multiple warehouses in different locations, goods from multiple warehouses can be consolidated into one local warehouse first, and then shipped from the consolidated local warehouse. Since the logistics time between multiple local warehouses is usually within 1 to 2 days, if goods are shipped from multiple local warehouses, it is recommended to calculate restock as if they are from one local warehouse.
(3) First mile refers to the transportation process of goods from the local warehouse to the FBA warehouse or from the local warehouse to the overseas warehouse. In transit refers to the logistic status when the goods are still in transit and have not arrived at the destination warehouse after being shipped.
(4) ERP (Enterprise Resource Planning) is an enterprise resource planning system, and in this application, it can also be used as an abbreviation for the ERP system.
(5) ASIN (Amazon Standard Identification Number) is the product identification number on the Amazon platform. In this application, it can broadly refer to the product identification number on an e-commerce platform. SKU (Stock Keeping Unit) refers to the inventory item code. SPU (Standard Product Unit) refers to the standardized product unit. MSKU (Merchant Stock Keeping Unit) refers to the online product code.
(6) Ideal state refers to the state where the inventory is sufficient, actual sales align with the average daily sales X, logistics deliver shipments on time, and there are no stockouts or backorders.
(7) Other noun explanations are provided in the following table (Table 1):

| | | Field | |
|---|---|---|---|
| NO. | Field Name | Symbol | Field Description |
| 1 | Historical Sales | X1 | The historical daily sales value of a product. |
| 2 | Estimated Sales | X2 | The estimated daily sales value of a product in a future |
| | | | time period, based on historical sales or historical and |
| | | | denoised sales. |
| 3 | Denoised Sales | X3 | The denoised daily sales value of a product obtained by |
| | | | removing noise from the historical sales within a certain |
| | | | time range. |
| 4 | Daily Average Sales | X | The average value of the estimated sales in a future time |
| | | | period. |
| 5 | FBA On-hand | Q11 | The quantity of products that have arrived and are stored |
| | Quantity | | in FBA warehouses. |
| 6 | FBA In-transit | Q12 | The quantity of products in-transit to FBA warehouses, |
| | Quantity | | including those being shipped from local and/or |
| | | | overseas warehouses. |
| 7 | FBA Inventory | Q1 | FBA Inventory = FBA On-hand Quantity + FBA |
| | | | In-transit Quantity |
| 8 | Current FBA | T41 | The number of days that current FBA inventory is |
| | Inventory Sellable | | expected to be sellable, calculated based on the daily |
| | Days | | average sales. Current FBA Inventory Sellable Days = |
| | | | FBA Inventory/Daily Average Sales. |
| 9 | Safety Days | T32 | The buffer time set to prevent stockouts of FBA |
| | | | inventory. When the sellable days of a product fall |
| | | | below the safety days, it is time to replenish the |
| | | | inventory. |
| 10 | Interval Days | T31 | The estimated time interval between two consecutive |
| | | | shipments using a specific logistics method. This |
| | | | interval serves as the initial benchmark for product |
| | | | restock frequency. |
| 11 | Safety Inventory | Q5 | Safety Inventory = Safety Days * Daily Average Sales |
| 12 | Target Inventory | Q6 | Target Inventory = (Safety Days + Interval Days) * |
| | | | Daily Average Sales |
| 13 | Current Date (Time) | t0 | The date of the current time. |
| 14 | Sellable Deadline | t05 | Sellable Deadline = Current Time + Current FBA |
| | | | Inventory Sellable Days |
| 15 | Overseas | Q32 | The quantity of products that have arrived at the |
| | Warehouse | | overseas warehouse and are available for shipment to |
| | Available | | any destination. |
| 16 | Overseas | Q31 | The quantity of products that have arrived at the |
| | Warehouse | | overseas warehouse and have been allocated to specific |
| | Occupied | | destinations for shipment. |
| 17 | Overseas | Q33 | The quantity of products that are in transit to the |
| | Warehouse | | overseas warehouse. |
| | In-transit | | |
| 18 | Overseas | Q3 | Overseas Warehouse Inventory = Overseas Warehouse |
| | Warehouse | | Occupied + Overseas Warehouse Available + Overseas |
| | Inventory | | Warehouse In-transit |
| 19 | Overseas | T22 | The duration required to ship products from the overseas |
| | Warehouse to FBA | | warehouse to the FBA warehouse and the unit is in |
| | Warehouse | | days. |
| | Shipping Duration | | |
| 20 | Overseas | tn3 | The date when products are shipped from the overseas |
| | Warehouse to FBA | | warehouse to the FBA warehouse. |
| | Shipment Date | | |
| 21 | Quantity shipped | N3 | The quantity of products shipped from the overseas |
| | from overseas | | warehouse to the FBA warehouse. |
| | warehouse to FBA | | |
| | warehouse | | |
| 22 | Local Warehouse | Q22 | The quantity of products that have arrived at the local |
| | Available | | warehouse and are available for shipment to any |
| | | | destination. |
| 23 | Local Warehouse | Q21 | The quantity of products that have arrived at the local |
| | Occupied | | warehouse and have been allocated to specific |
| | | | destinations for shipment. |
| 24 | Purchase Plan | Q231 | The quantity of products that have been ordered from |
| | Quantity | | suppliers but have not yet been shipped. |
| 25 | Purchase In-transit | Q232 | The quantity of products that are in transit from the |
| | Quantity | | supplier's warehouse to the local warehouse. |
| 26 | Quantity to be | Q233 | The quantity of products that have arrived at the local |
| | Inspected | | warehouse from the supplier's warehouse but have not |
| | | | yet been inspected. |
| 27 | Quantity for | Q234 | The quantity of processed products that have arrived at |
| | Processing | | the local warehouse from the supplier's warehouse but |
| | | | have not yet been fully processed. |
| 28 | Local Warehouse | Q23 | Local Warehouse In-transit = Purchase Planned |
| | In-transit | | Quantity + Purchase In-transit Quantity + Quantity to be |
| | | | Inspected + Quantity for Processing |
| 29 | Local Warehouse | Q2 | Local Warehouse Inventory = Local Warehouse |
| | Inventory | | Occupied + Local Warehouse In-transit + Quantity for |
| | | | Processing |
| 30 | Purchase Planned | T11 | The lead time from when a purchase order is placed by |
| | Lead Time | | the buyer to when the supplier confirms the order. The |
| | | | default unit is days, and it can be set or modified in the |
| | | | product module's product list. |
| 31 | Purchase Delivery | T12 | The time required for products to be delivered from the |
| | Time | | supplier to the local warehouse, including the time for |
| | | | order generation and other processes. The default unit is |
| | | | days. |
| 32 | Quality Inspection | T13 | The time required to inspect the products after they |
| | Time | | arrive at the local warehouse (pre-storage). The default |
| | | | unit is days. |
| 33 | Processing Time | T14 | The time required to further process the products after |
| | | | they arrive at the local warehouse and pass the |
| | | | inspection stage, such as labeling or repackaging. The |
| | | | default unit is days. |
| 34 | Local Warehouse to | T21 | The time required to ship products from the local |
| | Overseas | | warehouse to the overseas warehouse. The default unit |
| | Warehouse | | is days. |
| | Shipping | | |
| | Duration(time) | | |
| 35 | Local Warehouse to | T22 | The time required to ship products from the local |
| | FBA Warehouse | | warehouse to the FBA warehouse. The default unit is |
| | Shipping | | days. |
| | Duration(time) | | |
| 36 | Minimum Order | N4 | The minimum quantity that can be ordered from the |
| | Quantity | | supplier for a specific product. |
| 37 | Minimum Shipment | N5 | The minimum quantity that can be shipped from the |
| | Quantity | | pre-storage warehouse for a specific product. |
| 38 | Local Warehouse to | tn2 | The date when products are shipped from the local |
| | Overseas | | warehouse to the overseas warehouse. |
| | Warehouse | | |
| | Shipment Date | | |
| 39 | Local Warehouse to | tn1 | The date when products are shipped from the local |
| | FBA Warehouse | | warehouse to the FBA warehouse. |
| | Shipment Date | | |
| 40 | Quantity shipped | N2 | The quantity of products shipped from the local |
| | from local | | warehouse to the overseas warehouse. |
| | warehouse to | | |
| | overseas warehouse | | |
| 41 | Quantity shipped | N1 | The quantity of products shipped from the local |
| | from local | | warehouse to the FBA warehouse. |
| | warehouse to FBA | | |
| | warehouse | | |
| 42 | Suggested Purchase | t01 | The recommended start date for purchasing, which is |
| | Date | | calculated as the local warehouse shipment date minus |
| | | | the purchase lead time, or the current date(time) as the |
| | | | suggested purchase date. |
| 43 | Suggested | N6 | Refers to suggested minimum purchase quantity of |
| | Minimum Purchase | | products when one restock recommendation needs to be |
| | Quantity | | purchased. |
| 44 | Purchase Lead Time | T1 | The total time required for the entire purchasing |
| | | | process, including purchase planned lead time, purchase |
| | | | delivery time, and inspection time. |
| 45 | Restock Cycle | T | The total time required for restock, including the |
| | | | purchase lead time, logistics time, and selling |
| | | | time(duration). If no purchase is needed, the purchase |
| | | | lead time is zero. |
| 46 | logistics lead time | T2 | The time required to transport products from the |
| | (logistics time) | | pre-storage warehouse to the FBA warehouse, including |
| | | | the local warehouse and/or overseas warehouse. |
| 47 | Sellable Days to | T42 | The number of days that the current FBA inventory is |
| | Reach Safety Stock | | expected to be sellable when it reaches the safety stock |
| | Level for Current | | level. T42 = Q1/X − T32. |
| | FBA Inventory | | |
| 8 | Current Date(time) | t0 | The current time of restock recommendation is |
| | | | calculated. Relative to the future time t, the current time |
| | | | is the time t = 0. |
| 49 | Future Time | t | The time periods after the current date, representing |
| | | | future events. |
| 50 | Lead Time for | T4 | The total lead time required for the entire restock |
| | Restock | | process, including the purchase lead time and the |
| | | | logistics time. T4 = T1 + T2. |
| 51 | Temporary Restock | tx | The date on which the restock of product arrives at the |
| | Date(day) | | FBA warehouse when the FBA inventory reaches the |
| | | | safety inventory. |
| 52 | Temporary Restock | Nx | The temporary restock quantity Nx is the quantity of |
| | Quantity | | product restocked on the temporary restock day tx, so |
| | | | that on the day when the product restocked on the |
| | | | temporary restock day tx arrive at FBA warehouse, the |
| | | | FBA on-hand quantity Q11 equals the target inventory |
| | | | Q6 |
| 53 | Restock Quantity | Nt | In other words, for a restock quantity of Nt for a |
| | for Future Time | | specific future time period t, the FBA inventory on the |
| | | | day the restock goods arrive at the FBA warehouse will |
| | | | be equal to the target inventory. |
| 54 | Current FBA | Q1″ | The current quantity of goods in FBA inventory at the |
| | Inventory | | current time, represented by the field symbol Q1″ or Q1. |
| 55 | Shipment Date from | tn | The temporary restock date from the pre-storage |
| | Pre-storage | | warehouse to the FBA warehouse, where the pre-storage |
| | Warehouse to FBA | | warehouse can be the local warehouse or overseas |
| | Warehouse | | warehouse. |
| 56 | Suggested Restock | tj | The final suggested restock date for replenishing the |
| | Date(day) | | FBA warehouse. |
| 57 | Suggested Restock | Nj | The final suggested restock quantity for replenishing the |
| | Quantity | | FBA warehouse. |

Among them, denoising refers to the process of re-evaluating values according to specific rules to exclude or reduce the impact of abnormal data on regular data. It can involve fixing or weighted percentage evaluation of historical sales data within a certain time range, taking the average value after removing the highest and lowest values, or taking the average value of historical sales outside a specific time period. The definitions of the fields and their symbols can be understood by referring to the accompanying patent drawings.

Referring to FIG. 3 and FIG. 4, the purchase time of the product is denoted as t01, the restock start time as t02, the time when FBA inventory reaches the target inventory as t03 (which is also the estimated time for the restock of the product to arrive), the time when FBA inventory reaches the safety inventory as t04, and the sellable deadline of the current FBA inventory as t05.

In the actual calculation of FBA On-hand Quantity, it can be based on either pre-sale or post-sale inventory. Pre-sale inventory refers to the remaining quantity of the existing sellable inventory in FBA warehouse on the day when a batch of products is shipped from local or overseas warehouses to FBA warehouses, starting from the beginning of that day (i.e., 0:00). Post-sale inventory refers to the remaining quantity of the existing sellable inventory in FBA warehouse on the day when a batch of products is shipped from local or overseas warehouses to FBA warehouses, ending at the end of that day (i.e., 24:00). Post-sale inventory=Pre-sale inventory−average daily sales.

The symbols used for the fields in this application are for the purpose of simplifying and distinguishing the representation of the fields, and do not restrict the use of the corresponding field symbols.

In this application, when calculating the various inventory quantities or the shipment and arrival time of the products, the scenarios of greater than and less than are primarily considered. The scenario of equal to can be classified as a scenario of greater than or a scenario of less than. Warehouse occupancy refers to the quantity of products in the warehouse that have been allocated for shipping to a specific destination. Warehouse availability refers to the quantity of products in the warehouse that are available for shipping to any destination.

In this application, the parameter settings for the fields can be manually entered or selected with corresponding parameter values. They can also be obtained from existing parameter values in related functional modules, or calculated from other parameters.

### BRIEF DESCRIPTION OF THE DRAWINGS

The accompanying drawings are provided to further understand the present application and do not constitute limitations to the present application; the content shown in the drawings can include actual data from embodiments and falls within the scope of protection of the present application.

FIG. 1 is a schematic diagram of the e-commerce ERP system module in an embodiment of the present application.

FIG. 2 is a schematic diagram of the restock process and inventory types of various warehouses in an embodiment of the present application.

FIG. 3 is a schematic diagram of the duration of each stage in the restock cycle in an embodiment of the present application.

FIG. 4 is a schematic diagram of the variation in FBA inventory when the FBA on-route quantity of the goods is zero in an embodiment of the present application.

FIG. 5 is a schematic diagram of the variation in FBA inventory when the FBA on-route quantity of the goods is not zero in an embodiment of the present application.

FIG. 6 is a schematic diagram of the restock programme flow based on the target inventory level in an embodiment of the present application.

FIG. 7 is a schematic diagram of the logistics distribution of three delivery programmes in an embodiment of the present application.

FIG. 8 is a schematic diagram of the restock programme flow based on multiple goods in an embodiment of the present application.

FIG. 9 is a schematic diagram of the restock programme flow based on a specified delivery time in an embodiment of the present application.

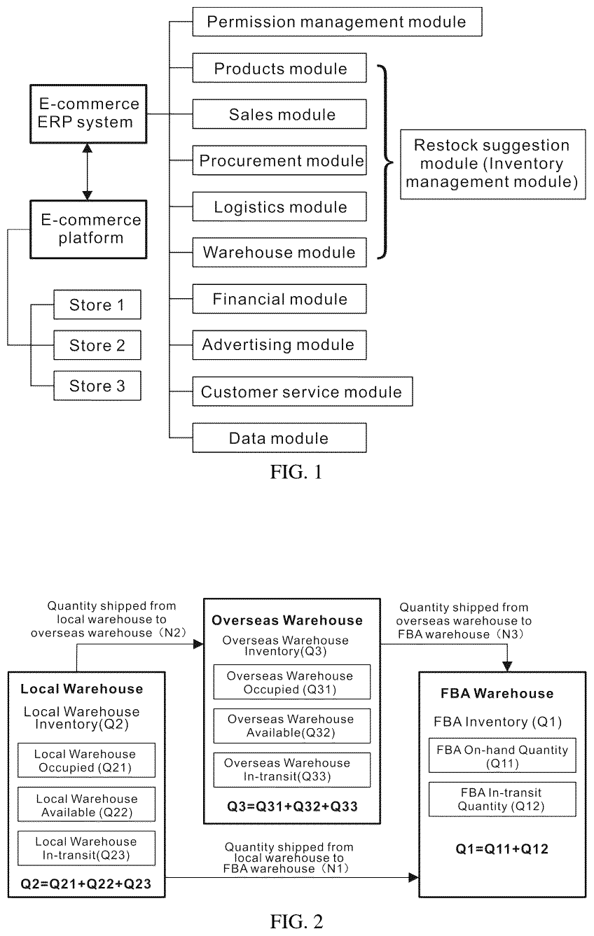

### DETAILED DESCRIPTION

In order to make the purpose, technical solutions, and advantages of the present application more clear, the following detailed description of an exemplary embodiment of the present application is provided with reference to the accompanying drawings. It should be understood that the exemplary embodiment described herein is only intended to explain the present application and is not intended to limit the present application.

Referring to FIG. 7, the present application proposes a merchandise restock programme (method) based on target inventory, which is used in the restock suggestion (recommendation) module of an e-commerce ERP system or e-commerce platform system. In an exemplary embodiment of the present application, the restock programme includes steps S1-S5 as follows.

Step S1: Obtain data access permissions for the merchandise in the store and retrieve FBA inventory data for the products (can be one or multiple sets of data). The FBA inventory data includes the FBA inventory level at the current time to, FBA On-hand Quantity (Q11), and FBA inventory in-transit (Q12) (Q1=Q11+Q12). Set the delivery logistics for the products from the pre-storage warehouse to the FBA warehouse and the corresponding transit time T2.

In related embodiments, multiple delivery logistics options can be pre-set for the products, including initial logistics and emergency logistics. The priority order of each logistics option can be adjusted. The restock suggestion module uses the highest priority delivery logistics to calculate the delivery time and quantity. Pre-setting multiple logistics options facilitates choosing the appropriate logistics for different scenarios. Typically, a slower but cheaper logistics option (such as shipping) is set as the initial logistics, while a faster but more expensive option (such as air shipping) is set as the emergency logistics. The initial logistics is usually set as the default logistics for merchandise restock, with the highest priority. When a stockout is predicted for a product, the emergency logistics can be set as the highest priority to expedite the arrival of the restock merchandise, avoiding stockouts within the corresponding timeframe. When pre-setting multiple delivery logistics options, the minimum delivery quantity (N5) and transit time (T2) are set for each delivery logistics option.

Step S2: Set the average daily sales (X) and the safety days (T32) for the product. Calculate the safety stock (Q5) by multiplying the average daily sales (X) by the safety days (T32) (i.e., Q5=T32*X). Set the interval days (T31) or the target inventory (Q6) for the product, such that the sum of the interval days (T31) and the safety days (T32) multiplied by the average daily sales (X) equals the target inventory (Q6) (i.e., Q6=(T31+T21)*X). When setting the interval days or the target inventory, the interval days (T31) can be calculated based on the transit time (T2) of the delivery logistics, for example, T31=T2/m, where m can be set as m≥2. A larger value of m indicates a higher frequency of product delivery, while a smaller value of m indicates a lower frequency of product delivery. By using the transit time (T2) and the interval days (T31), the approximate number of times the product needs to be delivered within the transit time (T2) can be determined. In other embodiments, a value less than 1 (m<1) can be used to increase the FBA On-hand Quantity. In theory, a lower interval days (T31) will result in a shorter time between two consecutive deliveries of the product. Typically, the interval days (T31) is set to be smaller than the transit time (T12) of the delivery logistics. The interval days (T31) is used to adjust the frequency of product restock, while the target inventory (Q6) remains constant and higher than the safety stock (Q5). The target inventory (Q6) remains fixed and does not change with the restock timing.

Step S3: Calculate the temporary restock date (tx) for the product based on the FBA inventory (Q1), safety stock (Q5), average daily sales (X), and transit time (T2) for delivery from the pre-storage warehouse to the FBA warehouse. The temporary restock date (tx) refers to the day when the restocked product arrives at the FBA warehouse on the same day that the FBA inventory (Q1) decreases to the safety stock (Q5), where the FBA inventory (Q1) decreases by the average daily sales (X) each day. In other words, on the day when the FBA inventory (Q1) decreases to the safety stock (Q5), the product restock arrives at the FBA warehouse on the temporary restock date (tx). The formula for calculating the temporary restock date (tx) is tx=t0+(Q1/X−T32−T2), where to is the current time and Q1 is the FBA inventory at the current time t0.

In practical applications, the FBA inventory quantity of a product is usually taken on a daily basis, and the inventory value or input value may be based on pre-sale inventory and post-sale inventory, which may result in a one-day deviation in inventory data depending on the chosen value. The corresponding FBA inventory may also have a one-day deviation. Therefore, the decrease of FBA inventory (Q1) to the safety stock (Q5) can be understood as restocking the product on the day when the FBA inventory (Q1) decreases to the safety stock (Q5), or restocking the product on the day after the FBA inventory (Q1) decreases to the safety stock (Q5). In this application, when referring to the decrease of inventory A to the level of inventory B, it means that the inventory A decreases to a value A1 at some future time, such that A1≤B and B−A1≤the average daily sales (X). The corresponding restock date can be understood as the arrival of the restock product at the FBA warehouse on the day when the inventory A decreases to the level of inventory B, or the arrival at the FBA warehouse on the day after the inventory A decreases to the level of inventory B.

The time value (Q1/X−T32) when the FBA inventory Q1 decreases to the safety stock Q5 may be an integer (e.g., 18.00 days) or contain a decimal (e.g., 18.66 days). In related implementations, the restock time can be determined based on whether Q1/X−T32 is an integer: If Q1/X−T32 is an integer, it is determined that the restock product arrives at the FBA warehouse on the same day that the inventory A decreases to the level of inventory B. If Q1/X−T32 contains a decimal, it is determined that the restock product arrives at the FBA warehouse on the day after the inventory A decreases to the level of inventory B.

Step S4: Calculate the temporary restock quantity Nx for the product based on the FBA On-hand Quantity Q6, the temporary restock date tx, the average daily sales X, and the transit time T2 for delivery from the pre-storage warehouse to the FBA warehouse. The temporary restock quantity Nx refers to the amount of products that need to be restocked on the day when the restock product arrives at the FBA warehouse and the FBA On-hand Quantity Q11 is equal to the target inventory Q6. In other words, on the day when the restock quantity Nx of the product is delivered and arrives at the FBA warehouse, the FBA On-hand Quantity Q11 is equal to the target inventory.

The merchandise restocked at time tx with quantity Nx will arrive at the FBA warehouse at time tx+T2. The FBA On-hand Quantity on the same day(tx+T2), denoted as Q11″, is calculated as Q11″=Q11+Q12+Nx−(tx+T2−t0)*X, where Q11 and Q12 are the FBA On-hand Quantity and FBA inventory in transit at the current time t0. According to the definition, Q11″=Q6, so we can deduce that Nx=Q6−(Q11+Q12)+(tx+T2−t0)*X, where Q11 and Q12 are the FBA On-hand Quantity and FBA In-transit Quantity at the current time t0. This formula can also be read as Nx=Q6−(Q11+Q12), in this formula, Q11 and Q12 represent the FBA On-hand Quantity and FBA In-transit Quantity at time tx+T2. In the actual calculation, the FBA On-hand Quantity on the day of arrival at the FBA warehouse can be based on pre-sale inventory or post-sale inventory. The FBA On-hand Quantity on the day when the restocked merchandise (product) arrives at the FBA warehouse (tx+T2) is the theoretical value calculated based on the average daily sales X, and does not include actual sales variations or product returns that may increase or decrease the quantity. In other implementations, the temporary restock quantity Nx can also be calculated as the quantity of merchandise (product) needed to restock when the FBA inventory Q1 on the day of arrival at the FBA warehouse is equal to the target inventory.

Step S5: Generate restock suggestion (recommendation) A based on temporary restock date tx and temporary restock quantity Nx,restock suggestion A is generated based on temporary restock date tx and temporary restock quantity Nx.Or, do not generate restock suggestion and further determine proposed restock date tj based on temporary restock quantity Nx. Then generate restock suggestion (recommendation) B based on proposed restock date tj and proposed restock quantity Nj.

Restock suggestion A's delivery suggestion is directly based on the restock time and quantity calculated according to the target inventory level. restock suggestion B's delivery suggestion, on the other hand, is based on the calculation results of restock suggestion A and further adjusts the restock time and quantity to improve accuracy.

Furthermore, step S1 can also include obtaining the purchasing lead time T1 (purchasing planned lead time=purchasing plan duration+purchase delivery time+quality inspection time+processing time) and the minimum shipment quantity N5 for shipping logistics. In specific implementation examples, if there is no field for the minimum shipment quantity or the field value is not set, the default value for N5 is 1 unit/shipment. Step S3 can also include calculating the number of days of available inventory for current FBA stock T41(Current FBA Inventory Sellable Days T41), calculated as T41=Q1/X; and calculating sellable days to reach safety stock level for current FBA inventory T42, calculated as T42=Q1/X−T32.

In step S5, when determining the proposed restock date tj based on the temporary restock quantity Nx, the calculation of the proposed restock date tj and proposed restock quantity Nj follows the restock rule R1. The restock rule R1 is determined through step P1, which includes steps P11 to P13, as follows.

Step P11: Calculate the initial proposed restock date tj′, using the formula tj′=t0+(T42−T2). In other words, the initial proposed restock date tj′ is a temporary value used to estimate the quantity of goods that can be shipped from the pre-storage warehouse on the estimated restock date.

Step P12: Calculate the stock on hand Qx for the pre-storage warehouse on the tj′ date. Qx can be estimated based on the current stock data and average daily sales X of the pre-storage warehouse, or it can be obtained directly from the stock data on the tj′ date. Qx includes the quantity of goods that are currently in transit but will arrive at the FBA warehouse on the tj′ date. The pre-storage warehouse can be either the local warehouse or the overseas warehouse, and the determination of the pre-storage warehouse is based on the logistics shipping programme set for the restock rule of the product, as shown in FIG. 7.

Step P13: Further determine the restock recommendation parameters [recommended restock date tj(the suggested restock day tj), recommended restock quantity Nj(the suggested restock quantity Nj), recommended purchase date t01 (the suggested purchase date t01), recommended minimum purchase quantity N6 (the suggested minimum purchase quantity N6)] based on the numerical values of Qx, Nx, and N5, including scenarios A, B, and C. The calculation process are as follows:

### (1) Scenario A: When T41>T2 and T42<T2,

If Qx≥Nx, then tj=t0+(T42−T2), and the recommended restock quantity Nj=Q6−Q1′, where Q1′ is the existing FBA inventory on the day of tj (excluding the quantity of goods restocked on that day, which will increase the in-transit inventory Nj). No need to purchase goods, and the recommended purchase date t01 is empty or null. The recommended minimum purchase quantity N6 is zero or empty.

If Qx<Nx and Qx≥N5, then tj=t0+(T42−T2), and the recommended restock quantity Nj=Qx′, where Qx′ is the on-hand quantity in the pre-storage warehouse on the day of tj. No need to purchase goods, and the recommended purchase date t01 is empty or null. The recommended minimum purchase quantity N6 is zero or empty.

If Qx<Nx and Qx<N5, the further determination of tj, Nj, t01, N6 based on T42, T2, and T1 includes:
\textcircled{1} If T42−T2≥T1, then tj=t0+(T42−T2−T1). In this case, the recommended restock quantity Nj=Q6−Q1′, where Q1′ is the existing FBA inventory on the day of tj. Goods need to be purchased, and the recommended purchase date t01=tj−T1. The recommended minimum purchase quantity N6=Nj−Qx′.
\textcircled{2} If T42−T2<T1, then tj=t0+T1. In this case, the recommended restock quantity Nj=Q6−Q1′, where Q1′ is the existing FBA inventory on the day of tj. Goods need to be purchased, and the recommended purchase date t01=10. The recommended minimum purchase quantity N6=Nj−Qx′, which means purchasing the goods immediately and shipping the goods immediately waiting for them to arrive at the pre-storage warehouse, to reduce logistics costs.

### (2) Scenario B: When T41>T2 and T42<T2,

If Qx≥Nx, then tj=t0 and it is recommended to reorder quantity Nj=Q6−Q1′, where Q1′ is the existing FBA inventory on the day tj. No need to purchase additional goods. It is suggested to leave t01 as empty or null. The suggested minimum purchase quantity N6 is zero or empty.

If Qx<Nx and Qx≥N5, then tj=t0 and it is recommended to reorder quantity Nj=Qx′, where Qx′ is the on-hand quantity stored in the pre-storage warehouse on the day tj. No need to purchase additional goods. It is suggested to leave t01 as empty or null. The suggested minimum purchase quantity N6 is zero or empty.

If Qx<Nx and Qx<N5, then tj=t0+T1 and it is recommended to reorder quantity Nj=Q6−Q1′, where Q1′ is the existing FBA inventory on the day tj. Additional goods need to be purchased. It is suggested to set t01 as t0. The suggested minimum purchase quantity N6 is Nj−Qx′.

### (3) Scenario C: When T41<T2,

If Qx≥Nx, then tj=t0 and it is recommended to reorder quantity Nj=Q6−Q1′, where Q1′ is the existing FBA inventory on the day tj. No need to purchase additional goods. It is suggested to leave t01 as empty or null. The suggested minimum purchase quantity N6 is zero or empty.

If Qx<Nx and Qx≥N5, then tj=t0 and it is recommended to reorder quantity Nj=Qx′, where Qx′ is the on-hand quantity stored in the pre-storage warehouse on the day tj. No need to purchase additional goods. It is suggested to leave t01 as empty or null. The suggested minimum purchase quantity N6 is zero or empty.

If Qx<Nx and Qx<N5, then tj=t0+T1 and it is recommended to reorder quantity Nj=Q6−Q1′, where Q1′ is the existing FBA inventory on the day tj. Additional goods need to be purchased. It is suggested to set t01 as t0. The suggested minimum purchase quantity N6 is Nj−Qx′.

This calculation suggests the restock rule R1 for determining the restock day tj, based on the sizes of T41, T2, and T42. It divides into three scenarios (Scenario A, B, C) and further subdivides into multiple sub-scenarios based on Qx, Nx, and N5. The corresponding sub-scenario is determined by matching Qx. Then, the formula for determining the restock day tj is obtained, along with other restock recommendation parameters. The restock rule R1 allows for flexible determination of shipping time, shipping quantity, procurement time, and procurement quantity, which ensures more timely shipping and procurement, and facilitates computer software programming. Additionally, the restock rule R1 can be further adjusted by temporary restock day tx and temporary restock quantity Nx, and improve the accuracy of the target inventory-based restock programme in different sub-scenarios, making it compatible with more application scenarios. It can be used for restock of distribution-type products, boutique-type products, boutique-type+distribution-type products, and restock of newly launched products with unstable sales, making it suitable for novice users.

In other implementation scenarios, when one or more parameters on which the restock rule R1 is based are specified or calculated using other rules, the other restock recommendation parameters can still be calculated based on the logic of Scenario A, Scenario B, and Scenario C. For example, when the restock time is specified, the recommended restock quantity Nj, the recommended purchase day t01, and the suggested minimum purchase quantity N6 can be calculated based on the restock rule R1. Similarly, if the initial restock day tj′ or the inventory quantity Qx stored in the pre-storage warehouse on the day tj′ is calculated using another rule, the recommended restock day tj, the recommended restock quantity Nj, the recommended purchase day t01, and the suggested minimum purchase quantity N6 can still be calculated based on the restock logic and purchase logic of the restock rule R1. Alternatively, if the restock day and restock quantity are already determined, the recommended purchase day t01 and the suggested minimum purchase quantity N6 can be calculated using the purchase logic of the restock rule R1.

If there is sufficient inventory in the pre-storage warehouse, the following conditions apply: In Scenario A, there will be no stockouts if the full shipment is made on the same day. In Scenario B, there will be stockouts but no out of stock situations if the full shipment is made on the same day. In Scenario C, there will be out of stock situations if the full shipment is made on the same day. Stockouts refer to having inventory in the FBA warehouse but the FBA On-hand Quantity being lower than the safety stock, while out of stock refers to the FBA On-hand Quantity is zero.

In other implementation scenarios, when determining the recommended restock day tj, recommended restock quantity Nj, recommended purchase day t01, or suggested minimum purchase quantity N6 for a product, they can be calculated separately based on Scenario A, Scenario B, or Scenario C. They can also be calculated based on one or more sub-scenarios within these scenarios, or by combining multiple sub-scenarios into a new scenario, or by using only a portion of the calculation logic from various sub-scenarios. Alternatively, in each sub-scenario of step P1, only the recommended restock day tj can be calculated, only the recommended restock quantity Nj can be calculated as step P2, or only the recommended purchase day t01 and/or suggested minimum purchase quantity N6 can be calculated as step P3. Then, based on step P1, step P2, or step P3, a restock recommendation B is generated, and restock recommendation B can include one or more of the recommended restock day tj, recommended restock quantity Nj, recommended purchase day t01, and suggested minimum purchase quantity N6. Based on restock recommendation A, the shipment recommendation is generated based on the recommended restock day tj and recommended restock quantity Nj, and the purchase recommendation is generated based on the recommended purchase day t01 and suggested minimum purchase quantity N6. The shipment and purchase recommendations of the restock recommendation are displayed in the restock recommendation module's restock recommendation list, the restock recommendation list serves as the main interface of the restock recommendation module, used for setting, calculating, and monitoring various field parameters.

Furthermore, the restock recommendation module generates a shipment plan based on the shipment recommendation derived from restock recommendation A or restock recommendation B. The restock recommendation module also generates a purchase plan based on the purchase recommendation derived from restock recommendation A or restock recommendation B. After creating the purchase plan and/or shipment plan in the restock recommendation module, the inventory data of the product will be updated, and the next restock recommendation will be generated based on the updated data.

The suggested minimum purchase quantity N6 is the minimum quantity of goods recommended for purchase on the suggested purchase day t01. In practice, it is advisable to purchase more goods than the suggested minimum purchase quantity, taking into account factors such as changes in product prices, changes in warehouse capacity, and seasonal fluctuations in sales. The suggested minimum purchase quantity N6 is typically greater than the minimum purchase(order) quantity N4 per shipment. When N6 is less than N4, the purchase quantity is set to N4. In specific implementation scenarios, if there is no field for the minimum purchase quantity per shipment or if the field value is not set, the default value for N4 is 1 item per shipment.

In one implementation scenario, to simplify the calculation in step P1, the value of Qx can be changed to the On-hand Quantity of the product in the pre-stored warehouse at time to. The calculation programmes for the other parameters in step P1 remain the same, in order to quickly calculate the recommended restock day, recommended restock quantity, recommended purchase day, and suggested minimum purchase quantity that are closer to the actual scenario.

In one implementation scenario, it is possible to pre-set the time period when logistics cannot ship and/or the time period when suppliers cannot make purchases in the restock recommendation module. If a time period when logistics cannot ship is set in the restock recommendation module (from time Ta1 to time Ta2), then it is further determined whether the recommended restock day tj falls within that time period. If tj falls within the time period when logistics cannot ship, then the recommended restock day is adjusted to the day before the start of that time period (Ta1−1), and the recommended restock quantity is adjusted to Nj+(Ta2−tj)*X. If tj does not fall within the time period when logistics cannot ship, then the recommended restock day tj and recommended restock quantity Nj are not adjusted.

If the restock recommendation module is pre-set with a non-purchasable time period (from time Tb1 to time Tb2), the further step is to determine if the suggested purchase day t01 falls within that non-purchasable time period. If t01 falls within the time period, the suggested purchase day will be adjusted to the day before the start of the time period (Tb1−1), and the suggested minimum purchase quantity will be adjusted to N6+(Tb2−t01)*X. If t01 does not fall within the time period, the suggested purchase day t01 and the suggested minimum purchase quantity N6 will remain unchanged.

In the implementation example, the restock recommendation module can also be equipped with reminders for restock and purchase times. When setting a reminder Tc1 days in advance for restock, the system will remind the user to restock in the Tel days before the suggested restock day tj. When setting a reminder Tc2 days in advance for purchases, the system will remind the user to purchase in the Tc2 days before the suggested purchase day t01. This allows users to coordinate shipping and purchasing matters in advance.

In an implementation example, the restock recommendation module periodically retrieves the FBA inventory data for the products. After the FBA inventory data is updated, the corresponding temporary restock day tx, temporary restock quantity Nx, suggested restock day tj, or suggested restock quantity Nj are recalculated based on the new FBA inventory data to improve the accuracy of the recommended restock quantity. For example, if the current calculation result of the restock recommendation module is to restock 200 units of a product on the following Wednesday, the FBA inventory data for the product is retrieved every day before the arrival of the following Wednesday. Due to the deviation between the actual daily sales volume and the average daily sales volume X, the calculation result of the restock recommendation module may suggest restocking 185 units of the product on the second day and 205 units on the third day. Updating the FBA inventory data can be synchronized with the data of the product store in the restock recommendation module, or the on-the-way data of the product can be updated separately.

Due to reasons like failure to restock in a timely manner, unsuccessful restock, or actual sales exceeding the daily average sales X, sellable days to reach safety stock level for current FBA inventory T42 that is less than the logistics lead time T2. In this case, the temporary restock day tx may become a negative value, which does not align with the actual restock scenario. Therefore, the restock recommendation module automatically calculates the value of T42 for each day based on T42=Q1/X−T32 and compares T42 with T2. If T42−T2<0, the restock recommendation module will remind the operation personnel to restock in a timely manner or recommend using logistics with a faster lead time than T2 for restock purposes.

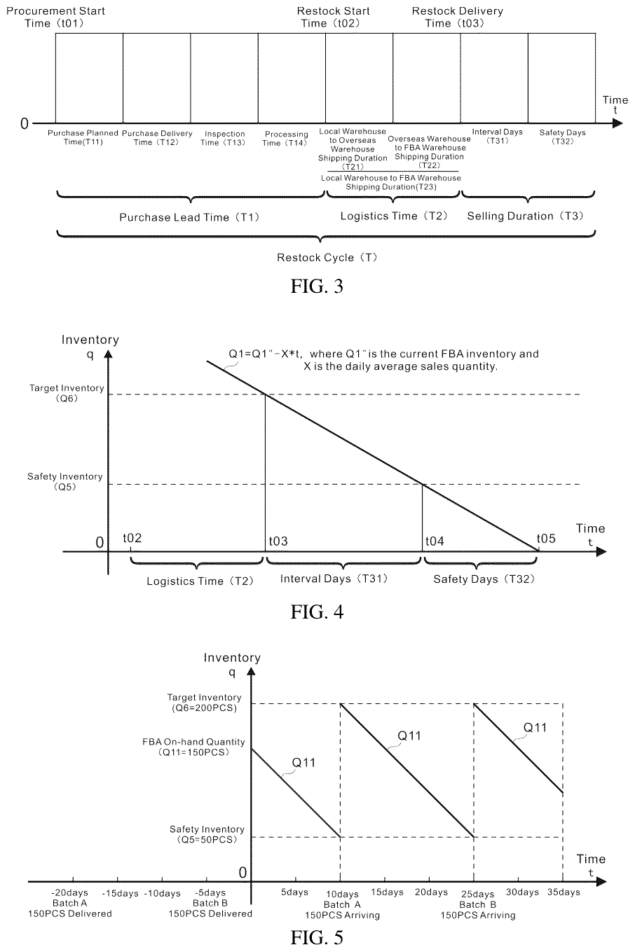

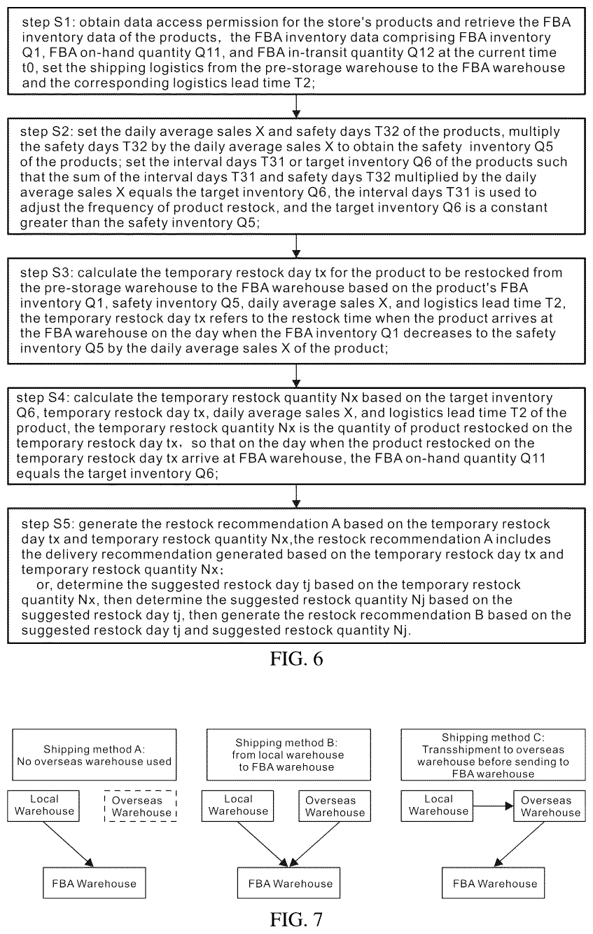

In an implementation example, as shown in FIG. 7 and FIG. 2-3, the pre-stored warehouse includes a local warehouse and an overseas warehouse. There are three shipping programmes for sending goods from the pre-stored warehouse to the FBA warehouse. Each shipping programme corresponds to different target warehouses for the pre-stored warehouse and logistics transportation. The target warehouses are the FBA warehouses in steps S1-S5 and steps P1-P3. (1) Shipping programme A does not use the overseas warehouse; the goods are stored in the local warehouse of the pre-stored warehouse, and the target warehouse is the FBA warehouse; the goods are shipped directly from the local warehouse to the FBA warehouse; in this case, T2=T23, and the restock recommendation for the goods is calculated according to steps S1-S5 and/or steps P1-P3. (2) Shipping programme B uses both the overseas warehouse and the local warehouse to ship goods to the FBA warehouse; when restocking, priority is given to shipping the goods from the overseas warehouse to the FBA warehouse. In this case, T2=T22, and the restock time and quantity are calculated according to steps S1-S5 and/or steps P1-P3; when the inventory in the overseas warehouse is insufficient, the goods are then shipped from the local warehouse to the overseas warehouse; in this case, T2=T23, and the restock recommendation for the goods is calculated according to steps S1-S5 and/or steps P1-P3. (3) Shipping programme C involves shipping the goods from the local warehouse to the overseas warehouse as a transit point, and then shipping them from the overseas warehouse to the FBA warehouse; when restocking, priority is given to shipping the goods from the overseas warehouse to the FBA warehouse; in this case, T2=T22, and the restock time and quantity are calculated according to steps S1-S5 and/or steps P1-P3; when the inventory in the overseas warehouse is insufficient, the goods are then shipped from the local warehouse to the overseas warehouse as a transit point before being sent to the FBA warehouse; in this case, T2=T21+T22, and the restock recommendation for the goods is calculated according to steps S1-S5 and/or steps P1-P3.

Case A: As shown in FIG. 5, suppose the delivery logistics duration for a certain product is T2=30 days, the average daily sales rate is X=10 units/day, the interval days between orders is T31=15 days, the safety days is T32=5 days, the current time is t0-0, and the current FBA inventory level is Q1=450 units (including an FBA On-hand Quantity Q11=150 units and an FBA in-transit inventory level of Q12=300 units; the in-transit products from the local warehouse to the FBA warehouse include batch A and batch B, with batch A having shipped 150 units 20 days ago and batch B having shipped 150 units 5 days ago, with batch A products arriving 10 days later and batch B products arriving 25 days later).

At this time, the calculations are as follows: (1) Safety stock Q5=T32*X=50 units and target stock Q6=(T31+T21)*X=200 units; (2) Current FBA inventory days of supply T41=Q1/X=45 days and FBA inventory days of supply to reach safety stock T42=Q1/X−T32=40 days; (3) Temporary restock day tx=t0+(Q1/X−T32−T2)=10 days (i.e. restock after 10 days), and the temporary restock quantity Nx is calculated as Nx=Q6−(Q11+Q12)+(tx+T2−t0)*X=150 units. Therefore, if the inventory quantity at the local warehouse is sufficient, the system recommends shipping 150 units of products from the local warehouse after 10 days, which is the restock recommendation A. If the inventory quantity at the local warehouse is not sufficient, further adjustments to the restock day can be made based on the various scenarios of restock rule R1.

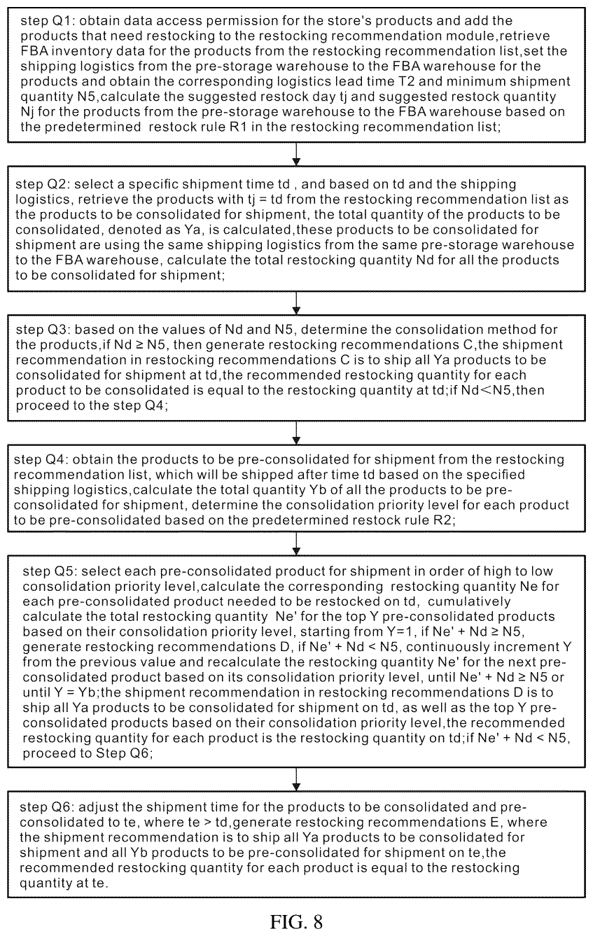

In the embodiment, referring to FIG. 8, the present application also provides a restock programme and corresponding system based on multiple products for the restock recommendation module of an e-commerce ERP system or e-commerce platform system. The programme includes steps Q1 to Q6 as follows.

Step Q1: Obtain data access permission for the store's products and add one or more products that need restock to the restock recommendation list of the restock recommendation module. The restock recommendation list obtains the FBA inventory data of each product and sets the delivery logistics from the pre-storage warehouse to the FBA warehouse to obtain the corresponding logistics duration T2(logistics lead time T2) and the minimum shipping quantity N5 of the delivery logistics. The restock recommendation list calculates the suggested restock day tj and suggested restock quantity Nj from the pre-storage warehouse to the FBA warehouse for each product according to the predetermined restock rule R1. The unit of the minimum shipping quantity N5 in this application is a quantity unit. When the logistics restricts the minimum shipping quantity of products based on other units such as volume or weight, the minimum shipping quantity in other units needs to be converted to a quantity unit before calculating the product consolidation for shipment.

Step Q2: Select a certain shipment time td (which can be the current time or a future time). Using td and the delivery logistics, select (by filtering or other programmes) the products in the restock recommendation list with t_j=td as the products to be consolidated for shipment. The quantity of all the products to be consolidated for shipment is Ya. These products to be consolidated for shipment use the same delivery logistics to ship from the same pre-storage warehouse to the FBA warehouse. Calculate the total restock quantity Nd for all the products to be consolidated for shipment. Nd is the sum of the recommended restock quantities of the products to be consolidated for shipment on the same day td. For example, in Case B: According to the predetermined restock rule R1, the products A1, A2, and A3 are recommended for shipment on the day td, with recommended restock quantities Nj1, Nj2, and Nj3 respectively. The average daily sales rates of these products are Xa1, Xa2, and Xa3 respectively. Then, A1, A2, and A3 are the products to be consolidated for shipment, and Nd=Nj1+Nj2+Nj3. When Ya=0, it means that there are no products to be shipped on that day, and Nd=0. In this case, the process can directly proceed to Step Q4.

Step Q3: Preliminarily determine the consolidation programme for the products based on Nd and N5. When Nd≥N5, it meets the consolidation condition and generates a restock recommendation(suggestion) C. The shipment recommendation of restock recommendation C is to ship all Ya products to be consolidated for shipment at td. The recommended restock quantities for each product to be consolidated for shipment are the recommended restock quantities at td (for example, in Case B, the shipment recommendation for restock recommendation C is to ship all products A1, A2, and A3 to be consolidated for shipment at td, with recommended restock quantities Nj1, Nj2, and Nj3 respectively). When Nd<N5, it does not meet the consolidation condition, and proceed to Step Q4.

Step Q4: Based on the delivery logistics, obtain the products from the restock list that will be shipped after td as pre-consolidation products. The total quantity of all pre-consolidation products is Yb. Determine the consolidation priority level for each pre-consolidation product according to the consolidation rule R2. The consolidation rule R2 can be to determine the consolidation priority level of each pre-consolidation product based on the order of the recommended restock day tj. The products that are restocked earlier have a higher consolidation priority level, while the products that are restocked later have a lower consolidation priority level. When there are multiple products that need restock on the same day, the product with a larger restock quantity has a higher consolidation priority level. When there are multiple products that need restock on the same day with the same restock quantity, the product with a higher average daily sales rate has a higher consolidation priority level, or the priority level can be specified by the user. For example, in Case B, the pre-consolidation products also include product B1, which is recommended to be restocked at tj=td+1, and product C, which is recommended to be restocked at tj=td+2. Then: (1) The pre-consolidation products are product B1, B2, and C; (2) Since the restock time of products B1 and B2 is earlier than that of product C, the consolidation priority level of products B1 and B2 is higher than that of product C. (3) Both products B1 and B2 are restocked on the same day, td+1. The consolidation priority level can be further determined based on the recommended restock quantities Nj of products B1 and B2. If the recommended restock quantity of product B1 is greater than that of product B2, then the consolidation priority level of product B1 is higher than that of product B2. The corresponding consolidation priority level order for each pre-consolidation product is B1>B2>C.

Step Q5: Select each pre-consolidation product in order of consolidation priority level, and calculate the corresponding restock quantity Ne for each pre-consolidation product when restocked at td. Calculate the total restock quantity Ne′ for the top Y (1≤Y≤Yb) pre-consolidation products according to their consolidation priority level, starting from Y=1. When Ne′+Nd≥N5, generate restock recommendation D. When Ne′+Nd<N5, continue to the next Y value, increasing Y by 1 each time, and re-calculate Ne′ for the next pre-consolidation product. Repeat this process until Ne′+Nd≥N5, or until Y=Yb. The shipment recommendation for restock recommendation D is to ship all Ya products to be consolidated for shipment at td, as well as the top Y pre-consolidation products with consolidation priority level from 1 to Y. The recommended restock quantities for each product are the recommended restock quantities at td. When Y=Yb and Ne′+Nd<N5, proceed to Step Q6. Ne′ is the sum of the recommended restock quantities for the top Y pre-consolidation products at td.

For example, in Case B, if the minimum shipping quantity N5 for the delivery logistics is 500 units, the products to be consolidated for shipment are A1, A2, and A3, and the pre-consolidation products are B1, B2, and C (with consolidation priority level order B1>B2>C). According to restock rule R1, the recommended restock quantities Nj for A1, A2, A3, B1, B2, and C at td are 100 units, 100 units, 100 units, 180 units, 150 units, and 120 units, respectively. The calculations are as follows: (1) Nd=300 units, and Nd<N5, which means that additional pre-consolidation products B1, B2, and/or C need to be included in the consolidation; (2) Since B1 has the highest consolidation priority level, when Y=1, Ne′ only includes product B1, and Ne′=180 units, and Ne′+Nd=480<N5, which does not meet the consolidation condition. Proceed to the next Y value; (3) When Y=2, Ne′ includes products B1 and B2, and Ne′=180 units+150 units=330 units, and Ne′+Nd=630>N5, which meets the consolidation condition. Therefore, the recommendation is to restock only the top 2-ranked products B1 and B2 from the pre-consolidation products. The recommended shipment for restock recommendation D is to ship products A1, A2, A3, B1, and B2 at td, with shipment quantities of 100 units, 100 units, 100 units, 180 units, and 150 units, respectively. If the minimum shipping quantity N5 for the delivery logistics is 1000 units, when Y=3, Ne′+Nd=750<N5, which does not meet the consolidation condition.

Step Q6: Adjust the shipment time for the products to be consolidated and the pre-consolidation products to te, where te>td, and generate restock recommendation E. The shipment recommendation for restock recommendation E is to ship all Ya products to be consolidated for shipment and all Yb pre-consolidation products at te. The recommended restock quantities for each product are the recommended restock quantities at te.

In Step Q6, the shipment time te is calculated based on td, where te=td+M, starting from M=1. Each value of M is used to calculate the total shipment quantity Nf for the products to be consolidated for shipment and the pre-consolidation products. Nf is calculated as the sum of the recommended restock quantities for each product at te, based on restock rule R1. When Nf≥N5, restock recommendation E is generated. When Nf<N5, continue to the next value of M, increasing M by 1 each time, and recalculate Nf at the. Repeat this process until Nf≥N5, and then stop increasing M. The value of the is calculated based on the last value of M.

In other implementation examples, the value of M can be further restricted. When M≥20% of the minimum safety days T32′, M is set as M=T32′*20% (if M<T32′*20%, M value remains unchanged). The te time and suggested restock quantity for each product can then be calculated. Here, T32′ represents the minimum value of safety days T32 for each pending shipment and pre-shipped product. By further limiting the value of M, delayed shipments can be avoided to reduce the risk of stock-outs. In other implementation examples, M can also be set as other fixed percentages of T32′, such as 5%, 10%, 15%, 25%, or 30% etc.

In steps Q1-Q6, the suggested restock quantity Nje for the pending shipment or pre-shipped product at the time can be calculated based on the suggested restock quantity Njd at td time. Nje=Njd+M*Xe, where Xe represents the daily average sales volume for the corresponding pending shipment or pre-shipped product.

In step Q1, the suggested restock day tj and suggested restock quantity Nj for each product can be calculated using the corresponding steps S1-S5. For example, obtain the FBA inventory data for each product, including FBA inventory Q1, FBA On-hand Quantity Q11, and FBA In-transit Quantity Q12 at the current time to. Set the daily average sales X and safety days T32 for each product, calculate the safety inventory Q5 as the product of T32 and X. Set the interval days T31 or target inventory Q6 for each product, so that the sum of T31 and T32 multiplied by X equals Q6. Calculate the available days T41 for the current FBA inventory, T41=Q1/X, and calculate T42 sellable days to reach safety stock level for current FBA inventory, T42=Q1/X−T32. Then, use steps P11-P13 to obtain more accurate suggested restock days tj and suggested restock quantities Nj.

In steps Q1-Q6, the products in the same batch are usually products with similar volume or weight, and can be small-sized products (such as products that are charged by piece for shipping). For products with large volume, it is generally only suitable to consolidate and ship different products with similar volume and weight.

Case C: Products A, B, and C are shipped from the local warehouse to the FBA warehouse using the same logistics programme. The minimum shipment quantity N5 is 1000 units per shipment. The daily average sales volume, interval days, and suggested restock day tj and suggested restock quantity Nj based on restock rule R1 are as follows: \textcircled{1} For product A, the daily average sales volume X is 50 units per day, the interval days T31 is 10 days, and the system suggests to restock 500 units of product A 3 days later, with tj=3 and Nj=500. \textcircled{2} For product B, the daily average sales volume X is 40 units per day, the interval days T31 is 10 days, and the system suggests to restock 400 units of product B 4 days later, with tj=4 and Nj=400. \textcircled{3} For product C, the daily average sales volume X is 50 units per day, the interval days T31 is 10 days, and the system suggests to restock 500 units of product C 8 days later, with tj=8 and Nj=500. If product A is selected to ship in td=3 days, and the shipment quantity of product A at td is less than N5, consolidation is required. The consolidation calculation process is as follows:
(1) Determine if the pending shipment product meets the consolidation requirements: Only product A needs to be shipped on day td, so the pending shipment product is product A. The total restock quantity Nd for the pending shipment product is 500 units. Since Nd<N5, all pending shipment products need to be consolidated.
(2) Perform basic calculations: If the shipment is made on td=3, then:
Product B is shipped tj−td=1 day earlier, and each day earlier reduces the daily average sales volume X units of product B. Therefore, the shipment quantity of product B on td is Nj−X*(tj−td)=400−40*1=360 units.
Product C is shipped tj−td=5 days earlier, and each day earlier reduces the daily average sales volume X units of product C. Therefore, the shipment quantity of product C on td is Nj−X*(tj−td)=500−50*5=250 units.
(3) Determine if the pre-shipped product meets the consolidation requirements: The pending shipment products after td are products B and C, so the pre-shipped products are products B and C. Since the suggested restock time for product B is earlier than that for product C, the consolidation priority of product B is higher than that of product C. First, check if the pending shipment products plus product B meet the shipment requirements. On td, the total shipment quantity of products A and B is Nf=500+360−860 units. In this case, Nf<N5, so it does not meet the consolidation requirements. Proceed to the next priority-ranked product, which is product C. At td, the total shipment quantity of products A, B, and C is Nf=500+360+250=1110 units. Nf≥N5, so it meets the consolidation requirements. The suggested restock is to ship products A, B, and Con td, with shipment quantities of 500, 360, and 250 units respectively.

Furthermore, if the minimum shipment quantity N5 in Case C is changed to N5=1200 units per shipment, then none of the pending shipment products and pre-shipped products meet the consolidation requirements for shipment on the same day td. In this case, the shipment time needs to be adjusted to te using Step Q6. The verification process starts from te=td+1, and each day is checked to see if the pending shipment products and pre-shipped products meet the consolidation requirements. The first day where the pending shipment products and pre-shipped products meet the consolidation requirements is identified as the te time.

In another implementation example, the restock recommendation list has a parameter filtering module. Through the parameter filtering module, users can select or set criteria for shipping logistics, suggested restock day, suggested purchasing day, range of suggested shipment quantity, and other fields. This allows users to filter and display products that meet the specified criteria in the restock recommendation list. The restock recommendation list can also monitor the stock-out time of products in the list. By setting a range for the stock-out time in the parameter filtering module, products that are out of stock within that time frame can be filtered and displayed. Additionally, the restock recommendation list can include a restock calendar, which calculates and indicates the specific quantities of products that need to be restocked on specific shipment days. This provides users with a comprehensive view of the restock data for future time periods.

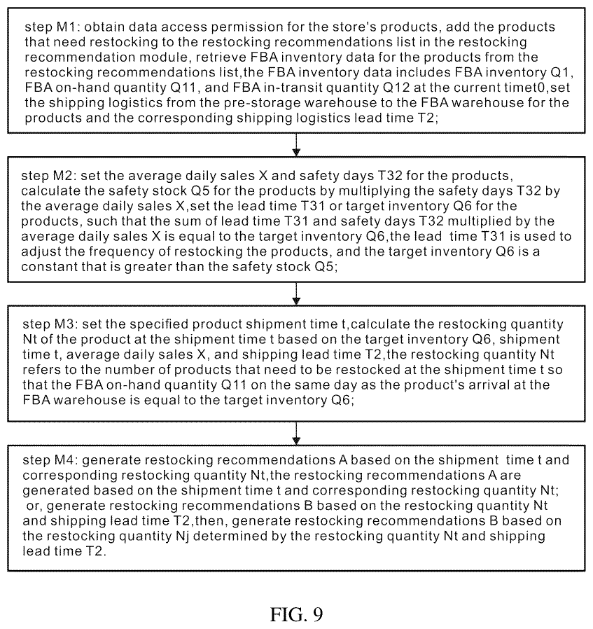

In one implementation example, as shown in FIG. 9, the present application also provides a restock programme based on specified shipment time for the restock suggestion module of an e-commerce ERP system or e-commerce platform system. The programme includes steps M1-M4, as follows.

Step M1: Obtain data access permission for the store's products and add the products that need restock to the restock suggestion list of the restock suggestion module. The restock suggestion list retrieves FBA inventory data for the products, including FBA inventory Q1, FBA on-hand quantity Q11, and FBA in-transit quantity Q12 at the current time to. Set the shipment logistics from the pre-storage warehouse to the FBA warehouse for the products and the corresponding logistics duration T2.

Step M2: Set the daily average sales volume X and safety days T32 for the products. Calculate the safety inventory Q5 for the products as the product of T32 and X. Set the interval days T31 or target inventory Q6 for the products, so that the sum of T31 and T32 multiplied by X equals Q6. The interval days T31 are used to adjust the shipment frequency for restocking the products, and the target inventory Q6 is a constant that is greater than the safety inventory Q5.

Step M3: Set the specified shipment time t for the products. Based on the target inventory Q6, shipment time t, daily average sales volume X, and logistics duration T2, calculate the restock quantity Nt for the products at the shipment time t. The restock quantity Nt refers to the quantity of products that need to be restocked on the day of arrival at the FBA warehouse, where the FBA on-hand quantity Q11 is equal to the target inventory Q6. In other words, when the products that have a restock quantity of Nt at the specified shipment time t arrival at the FBA warehouse, the FBA on-hand quantity is equal to the target inventory on the day the batch of restocked products arrives at the FBA warehouse. Calculate the temporary restock quantity Nt using the formula Nt=Nx=Q6−(Q11+Q12)+(t+T2−t0)*X, where Q11 and Q12 are the FBA on-hand quantity and FBA in-transit quantity at the current time t0, respectively.

Step M4: Generate restock suggestions A based on the shipment time t and corresponding restock quantity Nt. restock suggestions A are generated based on the shipment time t and corresponding restock quantity Nt. Alternatively, determine the suggested restock quantity Nj based on the restock quantity Nt and logistics duration T2, and then generate restock suggestions B based on the suggested restock quantity Nj.

In step M3, setting the specified shipment time t includes the following: Selecting the products that need to be shipped at the specified time from the restock suggestion list (multiple products can be selected together to set the same specified time, or each product can be set individually). Adjusting the shipment date of the selected products to a fixed shipment time t using the shipment date adjustment module. Once the shipment time t is set, the restock suggestion list recalculates the restock suggestions based on the specified shipment time t. The restock suggestion list displays the suggested restock quantity and suggested purchasing quantity for the products at the specified shipment time t. The shipment date adjustment module can be used to modify the already set shipment time. After modifying the shipment time, the restock suggestion list recalculates the restock suggestions based on the modified shipment time.

In other implementation examples, the specified shipment time t can be set as a fixed delivery date, such as weekly or monthly fixed shipment times (e.g., every Wednesday, or on the 10th of every month). After each fixed shipment time, the system automatically calculates the restock suggestions for the next fixed shipment time. The calculation of the restock quantity for the specified shipment time can be for a specific future day or for each day within a specific time period in the future.

In the other implementation examples, in step M4, the suggested restock quantity Nj, suggested purchasing day t01, and suggested minimum purchasing quantity N6 are calculated based on the restock rule R1. Compared to the restock rule R1 in step S5, in step M4, there is no need to calculate the preliminary restock day tj′ and temporary restock quantity Nx. Instead, both the preliminary restock day tj′ and the suggested restock day tj are adjusted to the specified shipment time t, and the value of the temporary restock quantity Nx is adjusted to Nt. First, the on-hand quantity Qx in the pre-storage warehouse on the specified restock time t is calculated, based on which the suggested restock quantity Nj, suggested purchasing day t01, and suggested minimum purchasing quantity N6 are calculated based on Qx, Nt, N5, T41, T2, and T42. The steps include:

In step M1, obtain the purchase duration T1 for the product and the minimum shipment quantity N5 for the shipment logistics. In step M2, calculate the available days T41 for the current FBA inventory, where T41=Q1/X; calculate T42 sellable days to reach safety stock level for current FBA inventory, where T42=Q1/X−T32.

In step M4, the restock rule R1 is followed when determining the recommended restock quantity Nj based on the restock quantity Nt and logistics lead time T2. The restock rule R1 calculates the recommended restock quantity Nj, the recommended purchase date t01 and the recommended minimum purchase through step P1. Amount N6, step P1 includes:
Step P12: Calculate the inventory quantity Qx(the On-hand Quantity Qx) of the pre-stocked warehouse on the specified day of restock time t;
Step P13: Further determine the recommended restock parameters based on the values of Qx, Nt and N5, including:

### (1) Scenario A: When T41>T2 and T42<T2,

If Qx≥Nt, it is recommended to restock the stock with Nj=Q6−Q1′, where Q1′ is the existing FBA inventory on day t. No need to purchase additional products. The recommended purchase date t01 can be left empty or unspecified(non-existent), and the recommended minimum purchase quantity N6 can be zero or left empty.

If Qx<Nt and Qx≥N5, it is recommended to restock the stock with Nj=Qx. No need to purchase additional products. The recommended purchase date t01 can be left empty or unspecified, and the recommended minimum purchase quantity N6 can be zero or left empty.

If Qx<Nt and Qx<N5, further determine Nj, t01, and N6 based on T42, T2, and T1, including:
\textcircled{1} If T42−T2≥T1, it is recommended to restock the stock with Nj=Q6−Q1′, where Q1′ is the existing FBA inventory on day t. Additional products need to be purchased. The recommended purchase date t01=t−T1, and the recommended minimum purchase quantity N6=Nj−Qx.
\textcircled{2} If T42−T2<T1, it is recommended to restock the stock with Nj=Q6−Q1′, where Q1′ is the existing FBA inventory on day t. Additional products need to be purchased. The recommended purchase date t01=t0, and the recommended minimum purchase quantity N6=Nj−Qx.

### (2) Scenario B: When T41>T2 and T42<T2,

If Qx≥Nt, it is recommended to restock stock with Nj=Q6−Q1′, where Q1′ is the existing FBA inventory on day t. No need to purchase goods. Recommended purchase date is t01 blank(non-existent) or empty. Recommended minimum purchase quantity is N6 zero or empty.

If Qx<Nt and Qx≥N5, it is recommended to restock stock with Nj=Qx. No need to purchase goods. Recommended purchase date is t01 blank or empty. Recommended minimum purchase quantity is N6 zero or empty.

If Qx<Nt and Qx<N5, it is recommended to restock stock with Nj=Q6−Q1′, where Q1′ is the existing FBA inventory on day t. Goods need to be purchased. Recommended purchase date is t01=t0. Recommended minimum purchase quantity is N6=Nj−Qx.

### (3) Scenario C: When T41<T2,

If Qx≥Nt, it is recommended to restock quantity Nj=Q6−Q1′, where Q1′ is the original FBA inventory on day t. No need to purchase goods, recommended purchase date t01 is empty or not applicable, and recommended minimum purchase quantity N6 is zero or empty.

If Qx<Nt and Qx≥N5, it is recommended to restock quantity Nj=Qx. No need to purchase goods, recommended purchase date t01 is empty or not applicable, and recommended minimum purchase quantity N6 is zero or empty.

If Qx<Nt and Qx<N5, it is recommended to restock quantity Nj=Q6−Q1′, where Q1′ is the original FBA inventory on day t. Goods need to be purchased, recommended purchase date t01=t0, and recommended minimum purchase quantity N6=Nj−Qx.

In the implementation example of step S5, in other implementation examples of step M4, when determining the recommended restock quantity Nj, recommended purchase date t01, or recommended minimum purchase quantity N6 for a product, it can be calculated separately according to scenario A, scenario B, or scenario C, or it can be calculated separately according to one or more sub-scenarios, or multiple sub-scenarios can be combined into a new scenario for calculation, or only a portion of the calculation logic of each sub-scenario can be used.

In one implementation example, in step M3, the specified product delivery time t can be cancelled. When the specified product delivery time t is cancelled, the restock recommendation list is recalculated based on the safety stock Q5. Step M2 also includes calculating the temporary restock date tx for the product to be shipped from the pre-storage warehouse to the FBA warehouse based on the FBA inventory Q1, safety stock Q5, average daily sales X, and logistics lead time T2. The temporary restock date tx refers to the restock time when the product just arrives at the FBA warehouse on the day when the FBA inventory Q1 is reduced to the safety stock Q5, and the FBA inventory Q1 decreases by the daily average sales X of the product inventory. At this time, the recommended restock date tj, recommended restock quantity Nj, recommended purchase date t01, and recommended minimum purchase quantity N6 can be re-determined based on steps S1-S5 and restock rule R1, as described earlier.

The programme of restock based on specified delivery time described in this application can be used to calculate the restock quantity, purchase date, and purchase quantity for a product with a specified delivery time td or an adjusted delivery time the in the steps Q1-Q6 of the programme of restock based on multiple products.

The various restock recommendation programmes described in this application can not only be applied to e-commerce ERP systems but also to e-commerce platforms, providing corresponding restock recommendations for the stores on the e-commerce platform. They can also be applied to other systems involving the need to restock products between different warehouses, where the pre-storage warehouse serves as the shipping warehouse and the FBA warehouse serves as the receiving warehouse. In this case, the field names may be adjusted accordingly.

In order to better distinguish and identify the values of the corresponding fields in different application scenarios, the symbols of the fields can be annotated with other approximate symbols. The letter identifiers in the restock recommendations A, B, C, D, E, or others with labels used in this application are for simplifying the description and distinguishing the restock recommendations obtained in different scenarios. Each restock recommendation corresponds to the restock recommendation displayed in the restock recommendation list in the respective scenario, and does not indicate the generation of multiple restock recommendations.

In one implementation example, the safety days T32 can have different values depending on the scenario, such as taking T32 to be greater than or equal to the fastest logistics lead time to ensure timely restock when below the safety stock; or taking T32 to be greater than the error value of the logistics lead time; or taking T32 to be greater than the deviation of the sales variation; or taking T32 to be greater than the error value of the procurement lead time.

In one implementation example, the restock recommendation module includes a sales chart that visually displays the historical sales and estimated sales data for the corresponding products. The x-axis of the sales chart represents the dates, including historical time, current time, and future time; the y-axis represents the sales of the products, showing historical sales for historical time and estimated sales for current time and future time. The estimated sales are calculated by assigning weights to the historical sales data and performing weighted calculations for the sales data in different time periods. The dates on the x-axis of the sales chart can be selected, such as choosing yesterday, the past 7 days, the past 30 days, this month, last month, the past 6 months, this year, or a specific time range. The sales of the products at different time points are connected to form the sales curve of the products. In the sales chart, the historical sales and estimated sales of the products can be represented using different colors. The sales chart visually represents the sales variation of the products in historical time, current time, and future time, providing a better representation of historical sales and estimated sales, and allowing the calibration of the formula used for estimating sales.

In the related implementation plan, the sales chart can also denoise the historical sales and display the estimated sales after denoising the historical sales. When denoising the historical sales, the out-of-stock days are excluded. If the daily sales are zero due to a zero FBA on-hand quantity on that day, it is considered as out-of-stock. In this case, the average daily sales for K days can be calculated as K-day total sales divided by (K−K1), where K1 is the number of out-of-stock days in the K-day period.

In one implementation example, the restock recommendation module records the data of average daily sales X and actual sales (historical data), calculates the percentage deviation between the average daily sales X and actual sales within a certain time period, and uses it as reference data for optimizing restock recommendations. If the deviation between the average daily sales X and actual sales exceeds a predefined range or value, the system prompts the user to adjust the average daily sales X or recommends the user to adopt a new value for the average daily sales X in order to reduce the deviation between the average daily sales and actual sales in the future. Similarly, the restock recommendation module can also record the logistics duration T2 or procurement duration T1 and the corresponding actual data (historical data), calculate the deviation, and if the deviation between the logistics duration T2 or procurement duration T1 and the actual data exceeds a predefined range or value, the system prompts the user to adjust the logistics duration T2 or procurement duration T1 or recommends the user to use a new value for the logistics duration or procurement duration. This helps to reduce the deviation between manually inputted data and actual data, and improve the accuracy of the data.

The above description is only an exemplary embodiment of the present application, and the scope of the present application is not limited thereto. Any equivalent transformations made under the conception of the present application, using the content of the present application and the accompanying drawings, or directly/indirectly applying in other related technical fields are also included within the scope of the patent protection of the present application.

What is claimed is:

1. An inventory target-based product restock method, for a restock recommendation module of an e-commerce ERP system or an e-commerce platform system, the method comprising:
step S1: obtain data access permission for products from a store and retrieve FBA inventory data of the products, the FBA inventory data comprising FBA inventory Q1, an FBA on-hand quantity Q11, and an FBA in-transit quantity Q12 at a current time to, set the shipping logistics from a pre-storage warehouse to the FBA warehouse and a corresponding logistics lead time T2;
step S2: set a daily average sales X and safety days T32 of the products, multiply the safety days T32 by the daily average sales X to obtain a safety inventory Q5 of the products; set interval days T31 or target inventory Q6 of the products such that a sum of the interval days T31 and safety days T32 multiplied by the daily average sales X equals the target inventory Q6, wherein the interval days T31 is used to adjust the frequency of product restocking, and the target inventory Q6 is a constant greater than the safety inventory Q5;
step S3: calculate a temporary restock day tx for the product to be restocked from the pre-storage warehouse to the FBA warehouse based on the product's FBA inventory Q1, safety inventory Q5, daily average sales X, and logistics lead time T2, the temporary restock day tx refers to the restock time when the product arrives at the FBA warehouse on a day when the FBA inventory Q1 decreases to the safety inventory Q5 by the daily average sales X of the product;
step S4: calculate a temporary restock quantity Nx based on the target inventory Q6, temporary restock day tx, daily average sales X, and logistics lead time T2 of the product, the temporary restock quantity Nx is the quantity of product restocked on the temporary restock day tx, so that on the day when the product restocked on the temporary restock day tx arrive at FBA warehouse, the FBA on-hand quantity Q11 equals the target inventory Q6;
step S5: determine the suggested restock day tj based on the temporary restock quantity Nx, then determine the suggested restock quantity Nj based on the suggested restock day tj, then generate the restock recommendation B based on the suggested restock day tj and suggested restock quantity Nj.

2. The inventory target-based product restock method as claimed in claim 1, wherein the step S1 further comprises: obtaining a purchase time T1 of the product and a minimum shipment quantity N5 of delivery logistics; and
the step S3 further comprises: calculating a current FBA inventory sellable days T41, through formula T41−Q1/X; and calculating sellable days to reach safety stock level for current FBA inventory T42, through formula T42=Q1/X−T32.

3. The inventory target-based product restock method as described in claim 2, wherein in the step S5, when determining the suggested restock day tj based on the temporary restock quantity Nx, the suggested restock date tj and suggested restock quantity Nj are calculated following restock rule R1, restock rule R1 is calculated through step P1, step P1 comprising:
step P11: calculate a preliminary restock day tj′, using formula tj′=t0+(T42−T2);
step P12: calculate an on-hand quantity Qx in the pre-storage warehouse on day tj′;
step P13: further determine the suggested restock day tj based on the values of Qx, Nx, and N5, comprising: (1) scenario A: when T41>T2 and T42>T2,
if Qx≥Nx, then tj=t0+(T42−T2);
if Qx<Nx and Qx≥N5, then tj=t0+(T42−T2);
if Qx<Nx and Qx<N5, then further determine tj based on T42, T2, and T1, comprising:
\textcircled{1} if T42−T2≥T1, then tj=t0+(T42−T2−T1),
\textcircled{2} if T42−T2<T1, then tj=t0+T1;
(2) scenario B: when T41>T2 and T42<T2,
if Qx≥Nx, then tj=t0;
if Qx<Nx and Qx≥N5, then tj=t0;
if Qx<Nx and Qx<N5, then tj=t0+T1; or
(3) scenario C: when T41<T2,
if Qx≥Nx, then tj=t0;
if Qx<Nx and Qx≥N5, then tj=t0;
if Qx<Nx and Qx<N5, then tj=t0+T1.

4. The inventory target-based product restock method as described in claim 3, wherein the restock rule R1 calculates the suggested restock quantity Nj through step P2 comprises:
(1) scenario A: when T41>T2, T42>T2,
if Qx≥Nx, then Nj=Q6−Q1′;
if Qx<Nx and Qx≥N5, then Nj=Qx′;
if Qx<Nx and Qx<N5, further determine Nj based on T42, T2, and T1, comprising:
\textcircled{1} if T42−T2>T1, then Nj=Q6−Q1′;
\textcircled{2} if T42−T2<T1, then Nj=Q6−Q1′;
(2) scenario B: when T41>T2, T42<T2,
if Qx≥Nx, then Nj=Q6−Q1′;
if Qx<Nx and Qx≥N5, then Nj=Qx′;
if Qx<Nx and Qx<N5, then Nj=Q6−Q1′; or
(3) scenario C: when T41<T2,
if Qx≥Nx, then Nj=Q6−Q1′;
if Qx<Nx and Qx≥N5, then Nj=Qx′;
if Qx<Nx and Qx<N5, then Nj=Q6−Q1′;
wherein Q1′ is the existing FBA inventory on day tj, and Qx′ is the on-hand quantity in the pre-stored warehouse on day tj.

5. The inventory target-based product restock method as described in claim 4, wherein the restock rule R1 calculates the suggested purchase date t01 and the suggested minimum purchase quantity N6 through the step P3, and step P3 comprises:
(1) scenario A: when T41>T2 and T42>T2,
if Qx≥Nx, then t01 is empty or non-existent, N6 is zero or empty;
if Qx<Nx and Qx≥N5, then t01 is empty or non-existent, N6 is zero or empty;
if Qx<Nx and Qx<N5, then t01 and N6 are further determined based on T42, T2, and T1, comprising:
\textcircled{1} if T42−T2≥T1, then t01=tj−T1, N6=Nj−Qx′,
\textcircled{2} if T42−T2<T1, then t01=t0, N6=Nj−Qx′;
(2) scenario B: when T41>T2 and T42<T2,
if Qx≥Nx, then t01 is empty or non-existent, N6 is zero or empty;
if Qx<Nx and Qx≥N5, then t01 is empty or non-existent, N6 is zero or empty;
if Qx<Nx and Qx<N5, then t01=t0, N6=Nj−Qx′; or
(3) scenario C: when T41<T2,
if Qx≥Nx, then t01 is empty or non-existent, N6 is zero or empty;
if Qx<Nx and Qx≥N5, then t01 is empty or non-existent, N6 is zero or empty;
if Qx<Nx and Qx<N5, then t01=t0, N6=Nj−Qx′.

6. The inventory target-based product restock method as described in claim 5, further comprising generating the restock recommendation B, and the restock recommendation B generates a shipment suggestion based on the suggested restock day tj and the suggested restock quantity Nj, and generates the purchase suggestion based on the suggested purchase date t01 and the suggested minimum purchase quantity N6.

7. The inventory target-based product restock method as described in claim 6, wherein the restock recommendation module generates a shipment plan based on the shipment suggestion derived from the restock recommendation B;
and/or, the restock recommendation module generates a purchase plan based on the purchase suggestion derived from the restock recommendation B.

8. The inventory target-based product restock method as described in claim 1, wherein the interval days T31 is set based on the logistics lead time T2 of the shipping logistics, satisfying T2/T31≥2;
and/or, when calculating the temporary restock day tx, through the formula tx=t0+(Q1/X−T32−T2), where Q1 is the FBA inventory at the current time t0;
and/or, when calculating the temporary restock quantity Nx, through the formula Nx=Nx=Q6−(Q11+Q12)+(tx+T2−t0)*X, where Q11 and Q12 are the FBA on-hand quantity and FBA in-transit quantity at the current time t0;
and/or, the shipping logistics of the product includes the initial logistics and emergency logistics, and the priority order of each logistics can be adjusted, the restock recommendation module uses the highest priority shipping logistics to calculate the shipment time and quantity;
and/or, the restock recommendation module periodically retrieves the FBA inventory data of the products, after the update of the FBA inventory data, the corresponding temporary restock day tx, temporary restock quantity Nx, suggested restock day tj, or suggested restock quantity Nj are recalculated based on the new FBA inventory data.

9. The inventory target-based product restock method as described in claim 1, wherein the restock recommendation module automatically calculates the T42 value for each day based on T42=Q1/X−T32, and determines the relationship between T42 and T2, when T42−T2<0, the restock recommendation module reminds an operator to restock or recommends using a logistics method that is faster than the logistics lead time T2 for restock.

10. An inventory target-based product restock system, wherein the system is an e-commerce ERP system or an e-commerce platform system, comprising the restock recommendation module which executes the operations of claim 1.
